(19) United States
(12) Patent Application Publication
(10) Pub. No.: US 2020/0238671 A1
(43) Pub. Date: Jul. 30, 2020

(54) Composite Cloth Structure With Cut Resistant Function

(71) Applicant: Nam Liong Enterprise Co., Ltd., Tainan City (TW)

(72) Inventor: Hui-Chih Lin, Tainan City (TW)

(21) Appl. No.: 16/259,133

(22) Filed: Jan. 28, 2019

(51) Int. Cl. B32B 27/12; B32B 27/18; B32B 27/40

(52) U.S. Cl. CPC B32B 27/12; B32B 27/18; B32B 2571/00; B32B 2307/581; B32B 2437/02; B32B 27/40

(57) ABSTRACT

A composite cloth structure includes a bottom cloth layer, an inner layer applied on a side of the bottom cloth layer, a plurality of hard particles stuck on the inner layer, and a wrapping layer applied on an outer face of the inner layer. The hard particles are partially exposed outward from the inner layer. The wrapping layer covers the inner layer and the hard particles fully and completely. Thus, the hard particles are encompassed entirely by the inner layer and the wrapping layer, and will not be detached or fall off due to an external force.

### BACKGROUND OF THE INVENTION

### 1. Field of the Invention

The present invention relates to a cloth structure and, more particularly, to a composite cloth structure.

### 2. Description of the Related Art

A wearable product, such as a glove, a clothing or the like, with a protective function, is used to protect the human body, such that when the operator is working in a situation, such as in mechanical maintenance or in building construction, the wearable product prevents the operator from being pierced or cut by a sharp or pointed tool, so as to protect the operator's safety. A conventional protective cloth structure comprises a bottom layer and a plurality of hexagonal protruding blocks mounted on the bottom layer. Thus, when the protective cloth structure is made into a wearable product, the hexagonal protruding blocks provide a puncture or cut resistant function so as to protect the user. However, the hexagonal protruding blocks are exposed outward, such that the hexagonal protruding blocks are easily detached from the bottom layer due to frequent friction during a long-term utilization, thereby decreasing the lifetime of the conventional protective cloth structure.

### BRIEF SUMMARY OF THE INVENTION

The primary objective of the present invention is to provide a composite cloth structure with a cut (or puncture) resistant function.

In accordance with the present invention, there is provided a composite cloth structure comprising a bottom cloth layer, an inner layer applied on a side of the bottom cloth layer, a plurality of hard particles stuck on the inner layer, and a wrapping layer applied on an outer face of the inner layer. The hard particles are partially exposed outward from the inner layer. The wrapping layer covers the inner layer and the hard particles fully and completely.

Preferably, each of the inner layer and the wrapping layer is made of PU (polyurethane) or emulsion.

Preferably, each of the hard particles is made of emery.

Preferably, the composite cloth structure further comprises a covering layer secured on an outer face of the wrapping layer. The covering layer is made of cloth.

According to the primary advantage of the present invention, the composite cloth structure has puncture resistant, cut resistant, and wearproof functions, so as to protect the user's safety.

According to another advantage of the present invention, the hard particles are encompassed entirely by the inner layer and the wrapping layer, and will not be detached or fall off due to an external force, such that the composite cloth structure has better durability.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partial cross-sectional view of a composite cloth structure in accordance with the preferred embodiment of the present invention.

### DETAILED DESCRIPTION OF THE INVENTION

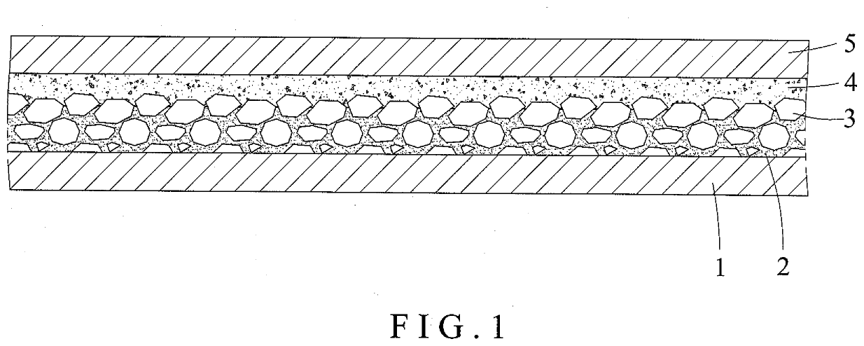

Referring to FIG. 1, a composite cloth structure in accordance with the preferred embodiment of the present invention comprises a bottom cloth layer 1, an inner layer 2 applied on a side of the bottom cloth layer 1, a plurality of hard particles 3 stuck on the inner layer 2, and a wrapping layer 4 applied on an outer face of the inner layer 2. The inner layer 2 is made of rubber, plastics, colloid, gel, glue or gum. The hard particles 3 are partially exposed outward from the inner layer 2. The wrapping layer 4 covers the inner layer 2 and the hard particles 3 fully and completely. The wrapping layer 4 is made of rubber, plastics, colloid, gel, glue or gum.

In the preferred embodiment of the present invention, each of the inner layer 2 and the wrapping layer 4 is made of PU (polyurethane) or emulsion.

In the preferred embodiment of the present invention, each of the hard particles 3 is made of emery (silicon carbide or alumina) or corundum.

In the preferred embodiment of the present invention, the composite cloth structure further comprises a covering layer 5 secured on an outer face of the wrapping layer 4. The covering layer 5 is made of cloth.

In fabrication, the inner layer 2 is initially spread or applied on the bottom cloth layer 1. Then, the hard particles 3 are provided on the inner layer 2. Then, the wrapping layer 4 is applied on the inner layer 2, and covers the inner layer 2 and the hard particles 3 fully and completely. Finally, the covering layer 5 is secured on the outer face of the wrapping layer 4. Thus, production of the composite cloth structure is finished. Then, the composite cloth structure is worked to form a product, including a glove, a clothing, a shoe insole or the like.

In use, the composite cloth structure comprises a large number of hard particles 3 which are distributed evenly between the inner layer 2 and the wrapping layer 4, to achieve puncture resistant, cut resistant, and wearproof functions, so as to protect the human body. At this time, the hard particles 3 are adhered to the inner layer 2 and are enclosed and covered entirely by the inner layer 2 and the wrapping layer 4, such that the hard particles 3 are still stuck on and will not be detached from the inner layer 2 and the wrapping layer 4 due to an external force (such as a piercing force, a cutting force or the like) during a long-term utilization, thereby enhancing the durability of the composite cloth structure.

Accordingly, the composite cloth structure has puncture resistant, cut resistant, and wearproof functions, so as to protect the user's safety. In addition, the hard particles 3 are encompassed entirely by the inner layer 2 and the wrapping layer 4, and will not be detached or fall off due to an external force, such that the composite cloth structure has better durability.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A composite cloth structure comprising:
a bottom cloth layer;
an inner layer applied on a side of the bottom cloth layer;
a plurality of hard particles stuck on the inner layer; and
a wrapping layer applied on an outer face of the inner layer;
wherein:
the hard particles are partially exposed outward from the inner layer;
the wrapping layer covers the inner layer and the hard particles fully and completely.

2. The composite cloth structure of claim 1, wherein each of the inner layer and the wrapping layer is made of PU (polyurethane) or emulsion.

3. The composite cloth structure of claim 1, wherein each of the hard particles is made of emery.

4. The composite cloth structure of claim 1, further comprising:
a covering layer secured on an outer face of the wrapping layer;
wherein:
the covering layer is made of cloth.
